(19) United States
(12) Patent Application Publication
(10) Pub. No.: US 2007/0079153 A1
(43) Pub. Date: Apr. 5, 2007

(54) Information handling system, current and voltage mode power adapter, and method of operation

(75) Inventors: William O. Bain, Leander, TX (US); Brent A. McDonald, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/243,810

(22) Filed: Oct. 5, 2005

(51) Int. Cl. G06F 1/26

(52) U.S. Cl. 713/300

(57) ABSTRACT

An information handling system includes a power rail to distribute power to at least a portion of the information handling system. A power adapter is or can be coupled to the power rail, the power adapter operable as a voltage source in a first power supply voltage/current region and operable as a current source in a second power supply voltage/current region. A battery control circuit couples a battery to the power rail, the battery control circuit capable of supplying current from the battery to the power rail when the power adapter is operating in at least a portion of the second power supply voltage/current region.

### BACKGROUND

The description herein relates to information handling systems having adapter-powered and battery-powered capabilities.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some IHS form factors are designed to be portable (e.g., a “laptop” or notebook IHS, tablet computer, palm computer, wireless device, or media player). These form factors generally include a limited capability to operate exclusively from a battery, and a separate capability to operate from another power source (standard AC wall power, an automobile power outlet, etc.) through a power adapter. Typically, the power adapter can also recharge the battery, with some systems allowing the battery to be recharged while the IHS is drawing power from the power adapter.

### SUMMARY

A power adapter for an information handling system includes a voltage control section to set an output voltage of the power adapter in a nominal supply voltage range when an output current of the power adapter is below a first current level. A current control section controls the output current of the power adapter when the output current of the power adapter is above the first current level. The current control section allows the output voltage of the power adapter to fall below the nominal supply voltage range.

### BRIEF DESCRIPTION OF THE DRAWINGS

FIG. 1 is a block diagram illustrating an embodiment of an information handling system.

FIG. 2 is a block diagram of a power adapter coupled to the information handling system of FIG. 1, according to an illustrative embodiment.

FIGS. 3A and 3B illustrate two current vs. voltage graphs, showing how the power adapter and battery supply power to an information handling system according to an embodiment under one set of conditions.

FIG. 4 is a circuit diagram of a battery control circuit according to an embodiment.

FIG. 5 shows a voltage vs. time graph for the battery control circuit of one embodiment slewing to transition from battery charging to supplementing the power adapter.

### DETAILED DESCRIPTION

For purposes of this disclosure, an information handling system (“IHS”) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

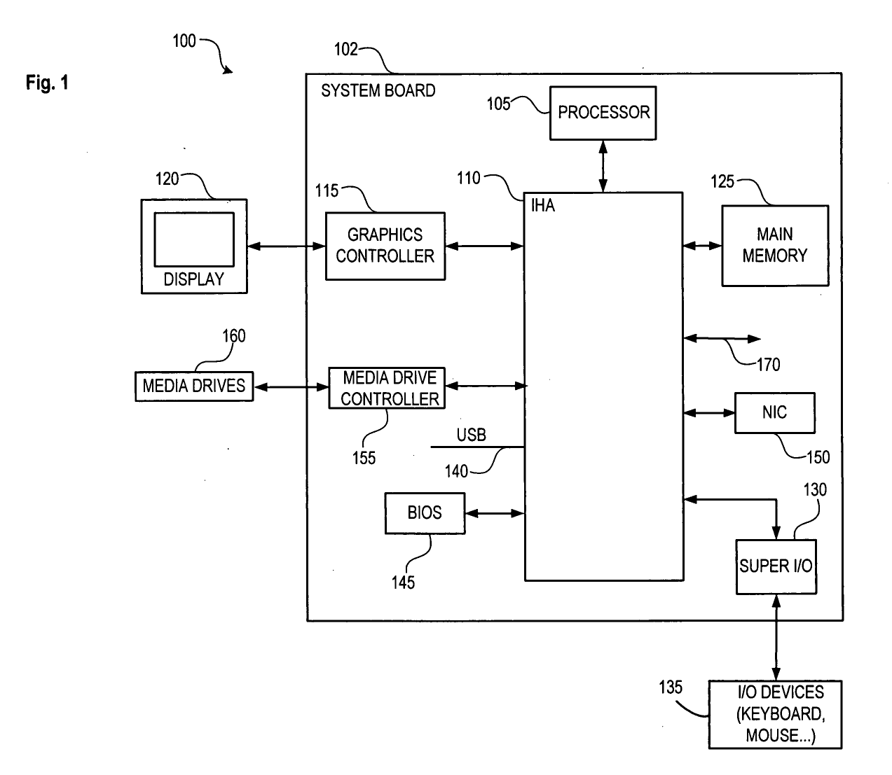

FIG. 1 is a block diagram of an information handling system (“IHS”), according to an illustrative embodiment. The IHS 100 includes a system board 102. The system board 102 includes a processor 105 such as an Intel Pentium series processor or one of many other processors currently available. An Intel Hub Architecture (IHA) chipset 110 provides the IHS system 100 with graphics/memory controller hub functions and I/O functions. More specifically, the IHA chipset 110 acts as a host controller that communicates with a graphics controller 115 coupled thereto. A display 120 is coupled to the graphics controller 115. The chipset 110 further acts as a controller for a main memory 125, which is coupled thereto. The chipset 110 also acts as an I/O controller hub (ICH) which performs I/O functions. A super input/output (I/O) controller 130 is coupled to the chipset 110 to provide communications between the chipset 110 and input devices 135 such as a mouse, keyboard, and tablet, for example. A universal serial bus (USB) 140 is coupled to the chipset 110 to facilitate the connection of peripheral devices to system 100. System basic input-output system (BIOS) 145 is coupled to the chipset 110 as shown. The BIOS 145 is stored in CMOS or FLASH memory so that it is nonvolatile.

A local area network (LAN) controller 150, alternatively called a network interface controller (NIC), is coupled to the chipset 110 to facilitate connection of the system 100 to other IHSs. Media drive controller 155 is coupled to the chipset 110 so that devices such as media drives 160 can be connected to the chipset 110 and the processor 105. Devices that can be coupled to the media drive controller 155 include CD-ROM drives, DVD drives, hard disk drives, and other fixed or removable media drives. An expansion bus 170, such as a peripheral component interconnect (PCI) bus, PCI express bus, serial advanced technology attachment (SATA) bus or other bus is coupled to the chipset 110 as shown. The expansion bus 170 includes one or more expansion slots (not shown) for receiving expansion cards which provide the IHS 100 with additional functionality.

Not all information handling systems include each of the components shown in FIG. 1, and other components not shown may exist. As can be appreciated, however, many systems are expandable, and include or can include some components that operate intermittently, and/or that can operate at multiple power levels. Thus an IHS generally has variable power needs, and, depending on configuration, can intermittently demand a peak power that is substantially higher than its average long-term power needs. The traditional approach to powering an IHS uses a power supply with a power rating sufficient to supply the peak power needs of the system.

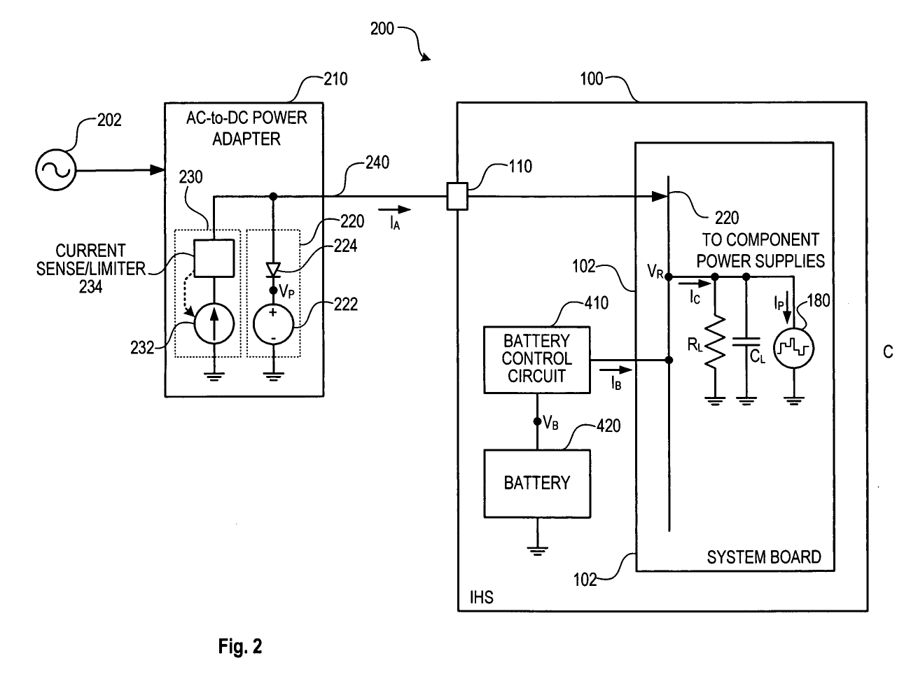

FIG. 2 is a block diagram of an IHS 100 in a configuration 200 with an external power adapter 210, an internal battery control circuit 410, and a battery 420, according to an illustrative embodiment. A power rail 220 on the system board 102 (and possibly routed to other locations in the system) supplies power to system components such as those shown in FIG. 1 and/or their secondary power supplies. From the perspective of power adapter 210 and battery 420, these components appear (approximately) as a distributed resistance R_{L} and capacitance C_{L}, coupled with a variable current sink Iₚ that represents the components' variable power demands. Power rail 220 connects to an external port 110, for connecting system 100 to power adapter 210 via a power cord 240 having an appropriate connector to mate with port 110 (port 110 will generally also provide a separate ground path, not shown). The battery control circuit 410 also connects to power rail 220, and supplies current to/from the battery 420 using a control scheme to be described below.

Power adapter 210 converts/conditions power to a range expected by power rail 220. In one embodiment, power adapter 210 receives power from a traditional AC power source 202, via, e.g., a wall outlet. Power adapter 210, when powered from an AC source, can contain common components (not shown) such as a transformer and rectification circuitry. These components supply power to the power adapter output circuitry shown in FIG. 2, including a voltage control section 220 and a current control section 230.

The voltage control section 220 can be designed as a constant voltage source 222 with a grounded negative terminal and a positive terminal V_{P} coupled to power cord 240 through a diode 224. The current control section 230 can be designed as a current source 232 coupled to power cord 240 through a current sense/limiter 234.

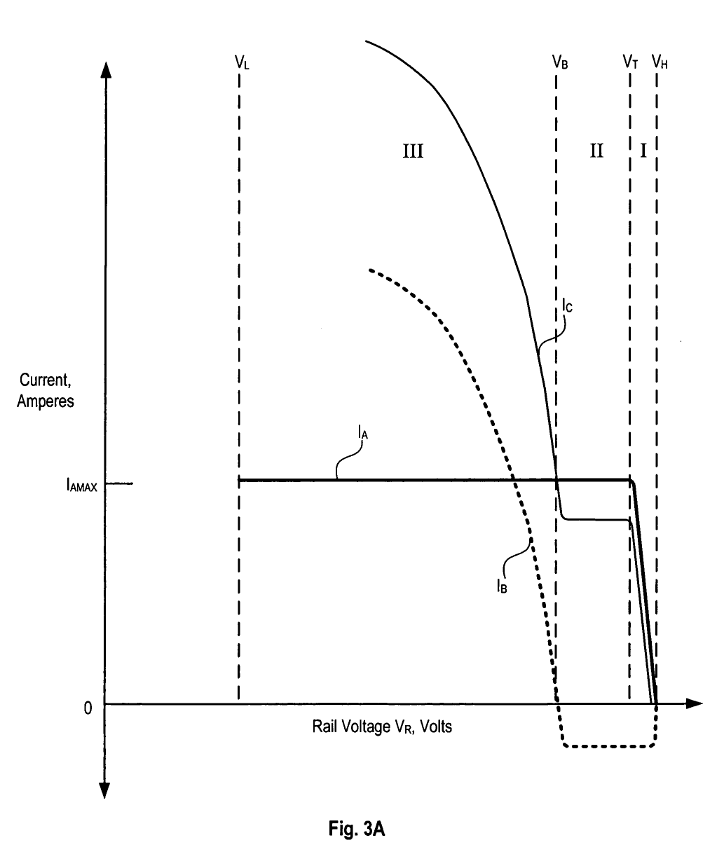

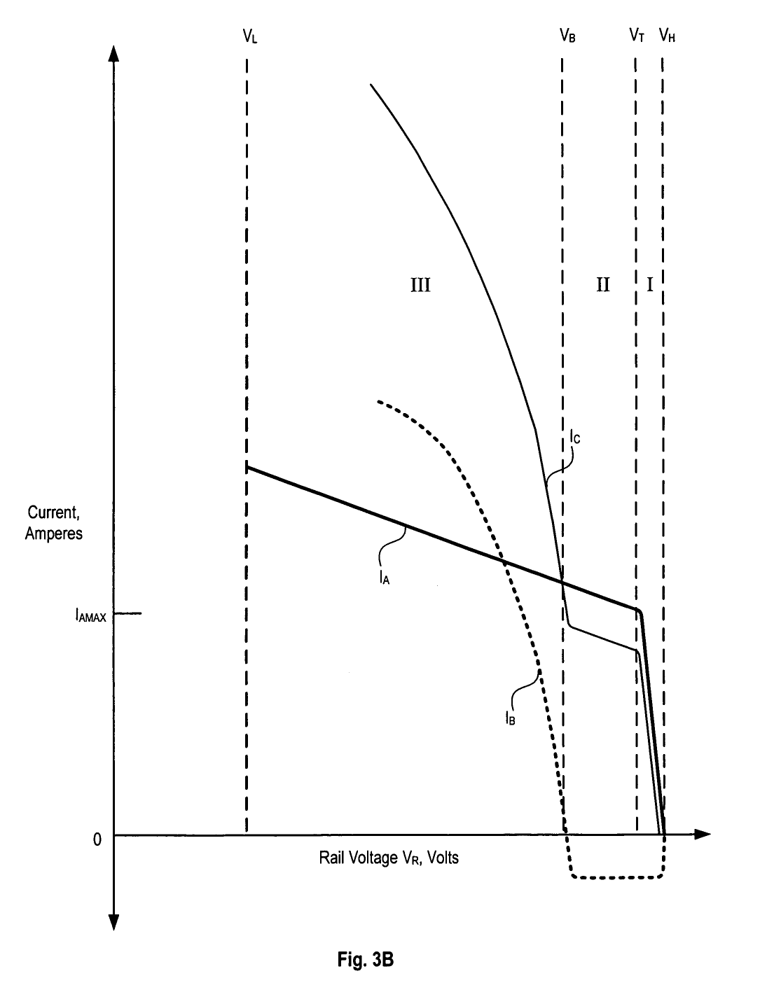

Operation of power adapter 210, for two different embodiments, is illustrated respectively in FIGS. 3A and 3B. Turning first to FIG. 3A, three different currents I_{A}, I_{B}, and I_{C} are plotted against the voltage V_{R} appearing at power rail 220. Current I_{A} is the current flowing from power adapter 210 to power rail 220. Current I_{B} is the current flowing from battery 420 through battery control circuit 410 to power rail 220 (current I_{B} will be negative when power adapter 210 is charging battery 420). Current I_{C} is the current flowing from power rail 220 to system components and secondary power supplies.

FIG. 3A identifies several different power supply voltage/current regions, each with different characteristics. Region I represents a nominal supply voltage range, with an upper end at a voltage V_{H} and a lower end at a voltage V_{T} (e.g., 20 V and 19.5 V, respectively, in one embodiment). Within this range, the battery control circuit draws current from the power rail to recharge battery 420 as needed, and power adapter 210 supplies enough current to both recharge the battery and supply the needs of the IHS components. The power adapter is preferably designed such that the rail voltage V_{R} falls predictably from V_{H} to V_{T} as more current is demanded by the system, finally reaching V_{T} as I_{A} rises to I_{AMAX}.

In some embodiments, region I offers sufficient power to simultaneously operate a processor, solid state memory, main disk drive, display, cooling fan, and possibly several other components of the system, but does not offer sufficient power to operate all primary and auxiliary components of the system at once. Thus under periods of larger demand (power needs greater than I_{AMAX} amperes at V_{T} volts), the power adapter drops into operation in regions II and III. Referring to the circuit model in FIG. 2 for adapter 210, voltage source 222 can be set such that it resists decreasing its voltage V_{P} more than one diode forward voltage drop below V_{T}. Thus as rail voltage V_{R} drops more than one diode forward voltage drop below V_{P}, diode 224 can no longer conduct forward current. At this point, voltage source 222 can no longer affect rail voltage V_{R}, and current source 232 does not attempt to control rail voltage V_{R}. Thus once voltage source 222 can no longer affect the rail voltage, the rail voltage is free to drop through region II toward region III.

In regions II and III, current source 232 attempts to deliver a constant current I_{A}=I_{AMAX} to power rail 220 without regard to the rail voltage. A current sense/limiter 234 includes the capability to disconnect current source 232 from power cord 240 (e.g., by tripping a mechanical or solid state circuit breaker), however, should the rail voltage decrease to a low threshold voltage V_{L}. This low threshold voltage can be selected, for instance, based on the design limitations of the power adapter current source (it may not be able to deliver constant current below some voltage), the desire to safeguard against a ground fault, and the expected range of operation of the battery. For instance, in the stated example where the nominal power adapter voltage range (region I) is 19.5 to 20 V, the battery may be fully charged at 17 V and fully discharged at 6 Volts. Under these conditions, V_{L} might be selected to have a value such as 12 volts, allowing the system to operate in regions II and III as long as the battery is charged to more than 12 volts. Although almost every system involves unique design considerations, many designers will find it desirable to use a minimum voltage in their embodiments, and to set this voltage at least 25% below the nominal supply voltage range to allow assistance from a battery at a range of battery charge levels.

Other embodiments need not select a constant current for current source 232 in regions II and III. For instance, FIG. 3B shows a second power adapter response that does not select a constant power adapter current in region II/III. Operation in region I is similar to that of FIG. 3A. Once power adapter 210 drops out of region I, however, it attempts to deliver a constant power level instead of a constant current as in FIG. 3A. Like in the prior embodiment, the power adapter does not attempt to set the rail voltage in regions II and III. Instead, current sense/limit circuit 234 monitors the power adapter output voltage (approximately V_{R}, ignoring resistive losses in power cord 240) and current I_{A}, and attempts to control current source 232 to deliver a current I_{A}=I_{AMAX}×(V_{T}/V_{R}) in regions II and III. This control loop can be set in some embodiments with a relatively long response time to prevent instability when the battery is assisting in power delivery, as will be explained next.

Those skilled in the art will recognize that other response curves are possible for power adapter 210, including without limitation stepped responses (the current is stair stepped in a desired response curve as rail voltage decreases) and smooth curves that lie somewhere between the examples shown in FIGS. 3A and 3B.

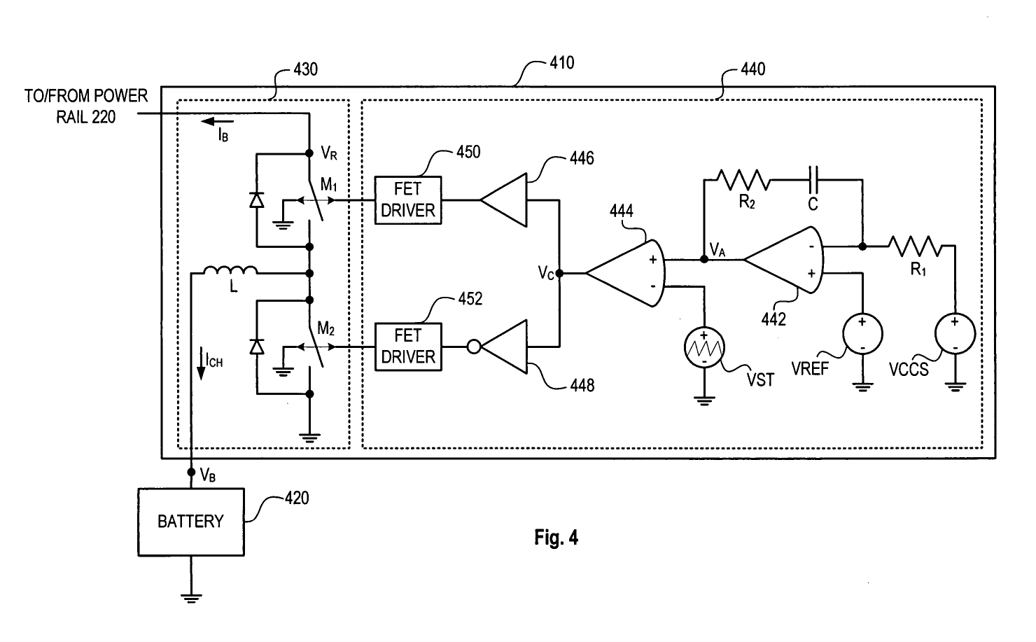

FIG. 4 contains a circuit diagram for an embodiment of battery control circuit 410, connected to battery 420. Battery control circuit 410 comprises two main subcircuits, a buck converter 430 and a buck converter driver circuit 440. Each will be described in turn.

Buck converter 430 comprises two power MOSFET (Metal Oxide Semiconductor Field Effect Transistor) switches M₁ and M₂ and an inductor L, with an inductance in one embodiment of 15 μH. MOSFET switch M₁ has a source-to-drain current path that couples a first end of inductor L to power rail 220 when the gate of M₁ is energized. The body diode of M₁ is connected as shown to resist current flow from the power rail to the inductor when the gate of M₁ is de-energized. MOSFET switch M₂ has a source-to-drain current path that couples the first end of inductor L to ground when the gate of M₂ is energized. The body diode of M₂ is connected as shown to resist current flow from the inductor to ground when the gate of M₂ is de-energized. The second end of inductor L is connected to battery 420.

Buck converter 430 is operated in two modes, a charging mode and a supply mode. In the charging mode, M₁ and M₂ are operated alternately, such that the first end of inductor L is alternately connected to V_{R} and to ground. Switching is performed at a relatively high rate compared to the effective time constant of inductor L. Since the inductor resists rapid changes in the current flowing through it, it responds to the switching of M₁ and M₂ by delivering a fairly level and controllable charging current I_{CH} to battery 420. Charging current I_{CH} depends on the battery voltage V_{B}, the rail voltage V_{R}, and the duty cycle of the buck converter, i.e., the percentage of the switching cycle during which M₁, as opposed to M₂, is operated. The charging current I_{CH} can be decreased by decreasing the duty cycle, and can be increased by increasing the duty cycle.

In the supply mode, MOSFET switch M₁ is continuously energized and MOSFET switch M₂ is continuously de-energized. Thus in supply mode, the power rail voltage V_{R} approaches the battery voltage V_{B}, although some resistance to instantaneous power demand changes is observed due to the existence of inductor L.

Buck converter driver circuit 440 is responsible for driving buck converter 430 in both the charging mode and the supply mode. Buck converter driver circuit 440 comprises: a battery charge current sense circuit VCCS that produces a voltage signal representative of the measured charging current supplied to the battery; a charging reference circuit VREF that produces a second voltage signal representative of a desired charging current; a first amplifier comprising an operational amplifier 442, resistors R₁ and R₂, and a capacitor C; a sawtooth signal generator VST; a second amplifier 444; a buffer 446; an inverter 448; and two FET drivers 450, 452.

The first amplifier is connected to battery charge current sense circuit VCCS and charging reference circuit VREF as follows. Charging reference circuit VREF is connected between ground and the non-inverting input terminal of operational amplifier 442. Battery charge current sense circuit VCCS is connected between ground and one end of resistor R₁. The opposite end of resistor R₁ connects to the inverting input terminal of operational amplifier 442. Resistor R₂ and capacitor C are connected in series between the inverting input terminal and output terminal of operational amplifier 442. In this configuration, the amplifier exhibits a frequency-dependent gain to differences between VREF and VCCS, with a high-frequency gain asymptotically approaching R₂/R₁, but allows the output voltage V_{A} to contain a DC component based on an integrated response.

Second amplifier 444 receives, at its non-inverting input terminal, the output voltage V_{A} of the first amplifier. The sawtooth signal generator VST is connected between ground and the inverting input terminal of second amplifier 444. No external feedback mechanism is provided for amplifier 444—thus the output voltage V_{C} of amplifier 444 slews as fast as possible to the amplifier's positive rail voltage when V_{A}>VST, and slews as fast as possible to the amplifier's negative rail voltage when V_{A}<VST. The second amplifier output voltage V_{C} ties to the inputs of buffer 446 and inverter 448, which respectively provide input signals to FET drivers 450 and 452. FET drivers 450 and 452 respectively provide gate drive signals to power MOSFET switches M₁ and M₂ of buck converter 430. Accordingly, when V_{A}>VST, power MOSFET switch M₁ is driven, and when V_{A}<VST, power MOSFET switch M₂ is driven.

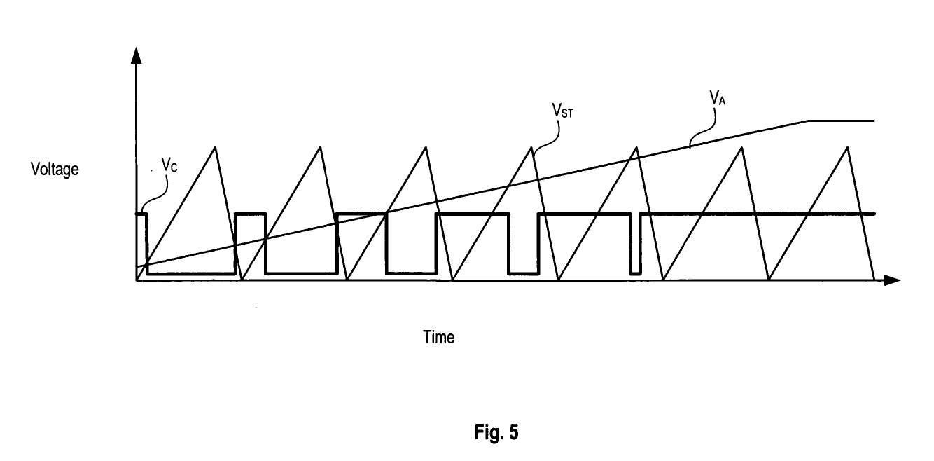

FIG. 5 shows a hypothetical response curve for second amplifier 444, as V_{A} slews while the battery control circuit transitions from controlling charging current to providing supply current to the information handling system. In this example, the initial condition had a relatively low value for V_{A}, sufficient to command a short duty cycle for buck converter 430 and supply a trickle charge to battery 420. As the power adapter transitions from region I through region II to region III (FIG. 3A), the buck converter driver circuit observes that battery charging current begins to decrease, and drives V_{A} higher to increase the buck converter duty cycle. Eventually the rail voltage will reach region III in FIG. 3A, when V_{A} in FIG. 5 passes completely above the peaks of VST, causing amplifier 444 to hold M₁ closed. At this point, again referring to FIG. 3A, the battery is connected to power rail 220 continuously, and determines the power rail voltage based on the amount of current drawn from the battery. The current supplied to the system now consists of the constant current I_{A} from the power adapter and the variable current I_{B} from the battery. Once the system no longer requires more power than the power adapter can deliver, this process reverses and the battery control circuit reverts to charging mode.

In a battery charging circuit such as circuit 410, it is often desirable to allow several different levels of battery charging current. For instance, different charge profiles may be preferable depending on the degree of battery depletion, the battery type or capacity, the amount of overhead current available for charging, etc. The design shown in FIG. 4 can accommodate such considerations by varying the reference voltage VREF. For instance, circuit 410 can monitor the charge state of the battery and select different values of VREF accordingly. Alternately, circuit 410 can receive instructions from the information handling system that affect the selection of a desired charging current.

In many embodiments, the power adapter will be housed in a separate unit that can be unplugged from the information handling system for portable usage of the IHS. In this situation the buck converter can be used to provide continued battery power to the system, or an alternate power path can be provided. The battery may be integrated into the IHS, removable, attached externally, or a combination of multiple batteries. It is left to the designer as to the power rating of the power adapter, although it is suggested that power adapter size, weight, and/or cost improvements can be realized in many embodiments by sizing the power adapter for less than the peak load that may be required by the information handling system. It is not necessary in all systems that the power adapter be capable of charging the battery, or that the batteries even be conventionally rechargeable. For instance, a fuel cell-type battery could provide the supplemental system current in voltage/current regions II and III, but would not be recharged in region I.

While the power adapter 205 charges the battery pack 215, the switch 410 is closed so that the batteries 405 are capable of receiving the charge currents. While charging the battery pack 215, the switch 415 is also closed so that the battery pack 215 is capable of supplying supplemental power to reduce voltage falls as discussed above (in connection with FIGS. 2 and 3).

Those skilled in the art will recognize that a variety of circuit designs are available to implement a power adapter that responds like a voltage source in one operating region and responds like a current source in another operating region. Such designs need not take the form shown in FIG. 2, which illustrates one possible arrangement incorporating separate voltage and current control. Although ideal current and/or voltage sources are useful in conveying an understanding of embodiment operation, those skilled in the art also recognize that actual implementations need not approach ideal voltage source and/or current source characteristics to be useful in a variety of designs.

Although illustrative embodiments have been shown and described, a wide range of other modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. An information handling system comprising:
a power rail to distribute power to at least a portion of the information handling system;
a power adapter coupled to the power rail, the power adapter operable as a voltage source in a first power supply voltage/current region and operable as a current source in a second power supply voltage/current region; and
a battery control circuit to couple a battery to the power rail, the battery control circuit capable of supplying current from the battery to the power rail when the power adapter is operating in at least a portion of the second power supply voltage/current region.

2. The information handling system of claim 1, the power adapter further comprising a voltage sense/limit circuit to turn off the power adapter when the voltage at the power rail decreases to a minimum voltage supported in the second power supply voltage/current region.

3. The information handling system of claim 1, the battery control circuit capable of drawing battery charging current from the power rail when the power adapter is operating in at least a portion of the first power supply voltage/current region.

4. The information handling system of claim 3, the battery control circuit comprising a buck converter to couple the battery to the power rail, and a buck converter driver circuit to set the buck converter to deliver charging current to the battery or supply current to the power rail.

5. The information handling system of claim 4, wherein the buck converter driver circuit comprises:
a battery charging current sense circuit to output a first reference signal representative of the charging current supplied to the battery;
a charging reference circuit to output a second reference signal representative of a desired charging current;
a first amplifier to generate a duty cycle signal based on the difference between the first and second reference signals;
a sawtooth signal generator; and
a second amplifier to amplify the difference between the duty cycle signal and the sawtooth signal, the amplified difference driving the buck converter, wherein the duty cycle signal is set greater than the peaks of the sawtooth signal when the battery is to supply current to the power rail.

6. The information handling system of claim 1, further comprising the battery.

7. The information handling system of claim 1, wherein the at least a portion of the information handling system powered using power distributed via the power rail comprises a processor.

8. The information handling system of claim 1, further comprising a power adapter connection port interposed between the power adapter and the power rail, the power adapter connection port allowing the power adapter to be uncoupled from the power rail.

9. The information handling system of claim 1, wherein the power adapter is sized such that it cannot supply sufficient power alone to the information handling system under peak information handling system load conditions.

10. A method of supplying power to an information handling system, the method comprising:
under a first set of load conditions, supplying current to the information handling system from a power adapter at a supply voltage set by the power adapter;
under a second set of load conditions, supplying current to the information handling system from the power adapter without controlling the voltage output at the power adapter; and
under the second set of load conditions, supplying supplemental current to the information handling system from a battery at a supply voltage determined by the battery.

11. The method of claim 10, further comprising under the first set of load conditions, drawing a portion of the current supplied by the power adapter to charge the battery.

12. The method of claim 10, further comprising under the second set of load conditions, shutting off the power adapter when the supply voltage determined by the battery decreases below a minimum voltage.

13. The method of claim 10, wherein the information handling system comprises a battery control circuit, the method comprising the battery control circuit controlling current flow to and from the battery, and wherein no explicit control communications exist between the power adapter and the battery control circuit.

14. The method of claim 13, wherein the power adapter ceases setting the supply voltage at a voltage higher than a supply voltage that can be determined by the battery.

15. The method of claim 14, wherein the battery control circuit controlling current flow to and from the battery comprises the battery control circuit attempting to deliver a desired charging current to the battery from the power adapter, and allowing current to flow from the battery when the desired charging current is unavailable.

16. The method of claim 15, wherein the battery control circuit selects the desired charging current based on the charge state of the battery.

17. The method of claim 15, wherein the battery control circuit selects the desired charging current based at least in part on an instruction from the information handling system.

18. A power adapter for an information handling system, the power adapter comprising:
a voltage control section to set an output voltage of the power adapter in a nominal supply voltage range when an output current of the power adapter is below a first current level; and
a current control section to control the output current of the power adapter when the output current of the power adapter is above the first current level, the current control section allowing the output voltage of the power adapter to fall below the nominal supply voltage range.

19. The power adapter of claim 18, further comprising an overload circuit to disable the power adapter when the output voltage of the power adapter falls below a minimum voltage, wherein the minimum voltage is at least 25% below the nominal supply voltage range.

20. The power adapter of claim 18, wherein the current control section attempts to control the output current of the power adapter to a constant current level.

21. The power adapter of claim 18, wherein the current control section attempts to control the output current of the power adapter to a constant power level.
